(19) United States
(12) Patent Application Publication
(10) Pub. No.: US 2008/0189105 A1
(43) Pub. Date: Aug. 7, 2008

(54) Apparatus And Method For Automatically Indicating Time in Text File

(75) Inventors: Ming Hsiang Yen, Kaohsiung City (TW); Jui Yu Yen, Kaohsiung City (TW); Ping-Hsia Chao, Taoyuan (TW)

Correspondence Address: APEX JURIS, PLLC, 12360 LAKE CITY WAY NORTHEAST, SUITE 410, SEATTLE, WA, 98125, US

(73) Assignee: MICRO-STAR INT'L CO., LTD., Junghe City (TW)

(21) Appl. No.: 11/835,964

(22) Filed: Aug. 8, 2007

(30) Foreign Application Priority Data
Feb. 1, 2007 (TW) 096103762

(51) Int. Cl. G10L 15/00; G10L 13/00

(52) U.S. Cl. 704/231; 704/260; 704/E15.001; 704/E13.001

(57) ABSTRACT

In an apparatus and a method for automatically indicating time in a text file, a receiver module receives a text file and a speech file, in which the text file is composed of a plurality of sentences; a speech recognition module transforms the sentences in the text file into a speech model, divides the speech file into a plurality of sound frames and assigns numbers to them in sequence in accordance with a time interval, turns speech data of the sound frames into feature parameters through speech capturing, and calculates the best speech route matching the sound frames with the speech model; an indicator module captures the assigned number of the sound frame corresponding to the beginning of each sentence in accordance with the best speech route, obtains a starting time of the speech file corresponding to the beginning of each sentence through the assigned number of the sound frame and a time interval and indicates the starting time in the text file.

### CROSS-REFERENCES TO RELATED APPLICATIONS

This non-provisional application claims priority under 35 U.S.C. §119(a) on Patent Application No(s). 096103762 filed in Taiwan, R.O.C. on Jan. 02, 2007, the entire contents of which are hereby incorporated by reference.

### FIELD OF INVENTION

The present invention relates to an apparatus and a method for indicating time in a text file, and more particularly to an apparatus and a method for processing automatic time indication in a text file through speech recognition.

### BACKGROUND

No matter what it is a language learner or speech player (for example, MP3 player), most facilities are all provided with lyric sync function currently. It is also to say that corresponding text (oral reading content or lyric) will be displayed together with a speech file when a user listens to speech reading or music play. Whereby, the user can listen to a speech file and read the text corresponding to the speech file simultaneously. Hence, the language learning efficiency can be elevated or the song learning efficiency can be accelerated when the user learns a language or listen to a song by using a facility provided with lyric sync function.

The currently common lyric sync file is LRC file. It is simply to say that the format of the so-called LRD file is that a length of text information follows behind time information, in which the time information represents a stating time of the length of the text information in the speech file. Therefore, a speech content corresponding to the length of text information can be heard as long as the speech is started to play from this time. Also, because files similar to such kind of format of LRC appear, many products or software provided with lyric sync function are available in the market.

But, the current technology only allows the fabrication of the LRC file to be completed mostly by man labor. I t is also that time indications corresponding to sentences are processed in accordance with the contents of text and speech files. Simply to say, it is that the times that text parts corresponding to speech file are indicated sentence by sentence by man labor and hence, this causes a great amount of time and man labor to be wasted.

For example, Taiwan Patent No. 92117564 entitled as “Editing system of karaoke lyric and method for editing and displaying said karaoke lyric” provides an application on an executable interface of a computer, when lyrics corresponding to karaoke music melody are edited as well as starting and end times of each length of song are defined through a user to use on displaying, the displaying of corresponding characters can be done and changed accurately in accordance with song progressing time to allow the user to accompany easily. The technology disclosed by the patent is that the lyrics corresponding to the karaoke music melody need to be edited though the user, i.e. the time indication by man labor mentioned above is adopted to allow a text file (lyrics) in a karaoke song to have the lyric sync function.

The main research content of the documents mentioned above are stressed on the skill of speech recognition, and unable to attain to automatic time indication of the text file corresponding to the speech file. Therefore, how to enable the text file to be automatically indicated with time therein to save time and money on the manual time indication is a problem need to be solved.

### SUMMARY

For improving the deficits mentioned above, the present invention proposes an apparatus and a method for automatically indicating time in a text file and processing automation time indication in a text file through speech recognition. Each sentence in the text file can be indicated with time corresponding to a speech file according to the present invention. Therefore, it is unnecessary to use man labor to indicate time that the text file corresponding to the speech file sentence by sentence as the prior art does so that the expense on time and man labor can be slashed.

An apparatus for automatically indicating time in a text file proposed by the present invention comprises a receiver module, speech recognition module and an indicator module.

The receiver module receives a text file and a speech file, in which the text file is composed of a plurality of sentences. The speech recognition module transforms the plurality of sentences in the text file into a speech model and divides the speech file into a plurality of sound frames according to a time interval and assigns numbers to them in sequence as well as calculates the best speech route that the sound frame and the speech model are match with each other. The indicator module captures an assigned number of the sound frame corresponding to the beginning of each sentence in accordance with the best speech route, obtains a starting time of the speech file corresponding to the beginning of each sentence through the assigned number of the sound frame and the time interval and indicates the starting time in the text file.

The present invention proposes a method for automatically indicating time in a text file; it processes an automatic time indication in a text file through speech recognition and comprises the following steps: receiving a text file composed of a plurality of sentences and a speech file, transforming the sentence in the text file into a speech model, dividing the speech file into a plurality of sound frames according to a time interval and assigning numbers to them in sequence, calculating the best speech route that the sound frame and speech model matches with each, capturing an assigned number of the sound frame corresponding to the beginning of each sentence according to the best speech route; obtaining a starting time of the speech file corresponding to the beginning of each sentence according to the assigned number of the speech frame and the time interval and finally, indicating the starting time in the text file.

### BRIEF DESCRIPTION OF THE DRAWINGS

The present invention can be more fully understood by reference to the following description and accompanying drawings, in which:

FIG. 1 is a block diagram of an apparatus for automatically indicating time in a text file;

FIG. 2 is a block diagram of a speech recognition module;

FIG. 3 is a graph of the best speech route;

FIG. 4 is a flow chart of a method for automatically indicating time in a text file; and

FIG. 5 is a flow chart of a method for calculating the best route in detail.

### DETAILED DESCRIPTION

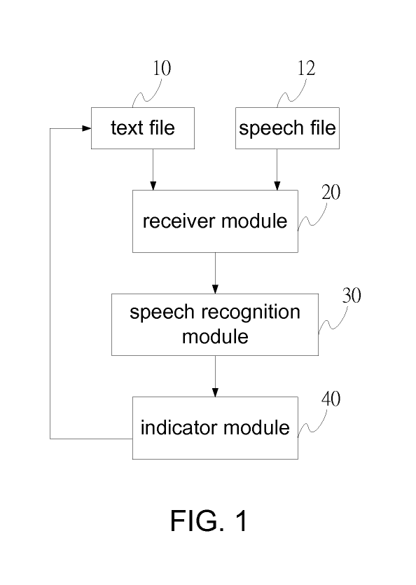

Please refer to FIG. 1. FIG. 1 is a block diagram of an apparatus for automatically indicating time in a text file. An apparatus for automatically indicating time in a text file comprises a receiver module 20, a speech recognition module 30 and an indicator module 40.

The receiver module 20 receives a text file 10 and a speech file 12 in which the text file and the speech file are files corresponding to each other, for example, the speech file 12 records the speech content of English oral reading conversation and the text file 10 is the text content of English oral reading conversation or the speech file 12 is a pop song and the text file 10 is the lyrics of the pop song. The text file is the same as a general article and records characters corresponding to the speech file 12. As a sheet of article is composed of multiple of sentences such that the text file 10 is also composed of a plurality of sentences.

The speech recognition module 30 transforms all sentences in the text file 10 into a speech model. Here, the speech model is a Hidden Markov Model (HMN). The so-called Hidden Markov Model is a statistics model and is used for describing a Markov process with implicit unknown parameters. The implicit parameters of the process are decided from the observable parameters, and the parameters are used to do a further analysis. The Hidden Markov Model is adopted in the current most speech recognition system; it uses a probability model to describe pronunciation phenomena and treats the pronunciation process of a small length of speech as a continuous state transformation in Markov Model.

As to transforming the text file into the speech model mentioned above, for example, if the text file 10 is English, The speech model is a Hidden Markov Model taught to form by using English vowels and consonants. Accordingly, when the text file 10 is English, each sentence in the text file 10 is transformed into a speech model composed of vowels and consonants.

Next, the speech file 12 is divided into a plurality of sound frames with assigned numbers in sequence in accordance with a time interval, in which the time interval is 23 to 30 milliseconds. A feature parameter shown by each sound frame can be treated as a result generated in a certain state. The transformation of the state and a result generated in a certain state can all be described with the probability model. No matter what it is the Hidden Markov Model or other speech recognition concepts to be used, the speech file 12 is first divided into basic speech units, i.e. the so-called sound frames, and the follow-up speech recognition process is then done so as to be able to elevate the convenience and the accuracy on the speech recognition process and in the meantime, the operational speed can be faster.

Furthermore, the speech recognition module 30 calculates the best speech route that the sound frame and the speech model matches with each other according to the plurality of sound frames divided in the speech file 12 and the speech model transformed from the text file 10.

The indicator module 40 captures the assigned number of the sound frame corresponding to the beginning of each sentence in the text file 10 in accordance with the best speech router generated from the speech recognition module 30 and obtains a starting time of the speech file 12 corresponding to the beginning of each sentence through the assigned number and the time interval. Suppose that the text file corresponding to the speech file 12 comprises four sentences. If the starting time of the sound frame of the speech file 12 is 30 seconds and it is the beginning of the second sentence of the text file through the result of the speech recognition, 30 seconds then is the starting time of the second sentence in the text file 10. Namely, when the playing time of the speech file 12 is 30 seconds, the played contented is exactly the beginning of the second sentence in the text file 10 such that 30 seconds is the starting time of the speech file corresponding to the second sentence in the text file 10. Similarly, if the starting time of the sound frame of the speech file 12 is 55 seconds and it is the beginning of the third sentence of the text file through the result of the speech recognition, 55 seconds then is the starting of the third sentence in the text file. Namely, when the speech file 12 is continued playing until time is 55 seconds, the played content is exactly the beginning of the third sentence in the text file 10, 55 seconds then is the starting time of the speech file 12 corresponding to the third sentence in the text file 10, and so on.

Furthermore, after the assigned number of the sound frame corresponding to the beginning of each sentence in the text file 10 is captured in accordance with the best speech route, as the time interval of the sound frame can be chosen by a user himself depending on the user's need or the requirements on calculation, the calculation of the starting time of each sentence can be obtained by multiplying the assign number of the sound frame corresponding to the beginning of each sentence and the time interval of each sound frame together. For example, suppose that the time interval is set to 25 milliseconds and each two sound frames are not folded together, namely, the speech file 12 is divided into one sound frame every interval of 25 milliseconds. Suppose that the assigned number of the sound frame corresponding to the beginning of the second sentence in the text file 10 captured by the best speech route is 1200, Because the time covered by each sound frame is 25 milliseconds, the starting time of the speech file 12 corresponding to the beginning of the second sentence in the text file 10 is the assigned number of the sound frame multiplied by the time interval (1200*25 ms=30 sec) and hence, the starting time of the speech file 12 corresponding to the beginning of the second sentence can be obtained as 30 sec. Similarly, the assigned number of the sound frame corresponding to the beginning of the third sentence in the text file 10 captured by the best speech route is 2200 such that the starting time of the speech file 12 corresponding to the beginning of the third sentence in the text file 10 is the assigned number of the sound frame multiplied by the time interval (2200*25 ms=55 sec) and hence, the starting time of the speech file 12 corresponding to the beginning of the third sentence can be obtained as 55 sec.

Finally, the indicator module 40 indicates the starting time in the text file 10. The starting time of a sentence is indicated in the text file 10 after the starting time of the speech file 12 corresponding to the beginning of each sentence in the text file 10 is obtained. Similar to the LRC file, the text file not only records the character content corresponding to the speech file 12 but also records the starting time of the beginning of each sentence. Hence, only if the speech file 12 is started playing from the starting time of a certain sentence, a speech content corresponding to the character content of the sentence can be heard such that the lyric sync function can be obtained. Besides, man labor is not needed to indicate time as the prior art does, each sentence in the text file 10 can be automatically indicated with the starting time corresponding to the speech file 12 through the apparatus disclosed by the present invention.

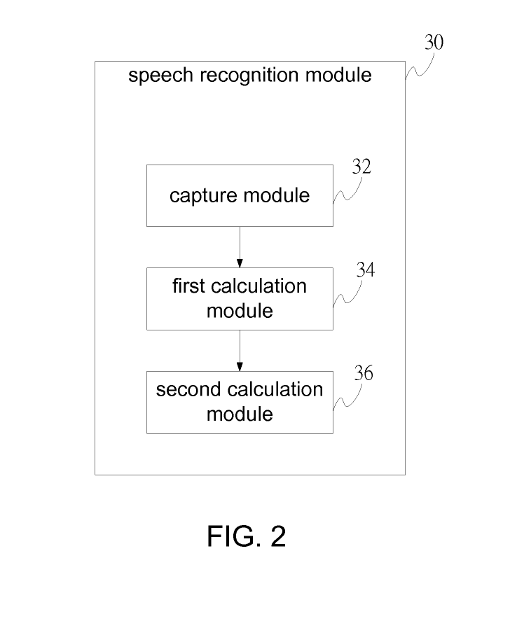

Please refer to FIG. 2. FIG. 2 is a block diagram of a speech recognition module. In the apparatus for automatically indicating time in a text file according to the present invention, the speech recognition module 30 comprises a capture module 32, a first calculation module 34 and a second calculation module 36.

A voice signal has an important characteristic that at different time, although an emitted speech is the same word or the same sound, the waveform thereof is not exactly the same, namely, the speech is a dynamic signal varied with time. The speech recognition is to find regularity from these dynamic signals, once the regularity is found, no matter how the voice signals vary with time, their characteristics can be pointed out more or less, and the voice signal can further be recognized. Such of regularity is called feature parameter on the speech recognition, namely, parameter capable of representing the voice signal characteristic, and the basic principle of the speech recognition is to take theses feature parameters as basis. Therefore, from the beginning, the capture module 32 first captures the feature parameter corresponding to every sound frame in the speech file 12 to benefit the follow-up speech recognition process.

Because the aforementioned speech model can be belong to Hidden Markov Model, and Hidden Markov Model is a method on probability and statistics and is suitable for being used on the description of the speech characteristics. Because speech is a multi-parameter random process signal, all parameters can be accurately figured out through the process of Hidden Markov Model. Next, the follow-up first calculation module 34 uses a first algorithm to calculate each feature parameter and a comparison probability of the speech model, in which the first algorithm can be a forward procedure algorithm or backward procedure algorithm. Suppose that the number of states of Hidden Markov Model is N, and Hidden Markov Model allows a certain state to be transferred to any other state, the number of all state transfer sequences then is N^{T}. If the T value is too large, the calculation amount of the probability is caused to be too heavy. Hence, the forward procedure algorithm or backward procedure algorithm can be adopted to speed the calculation of the comparison probability of the feature parameters and the speech model.

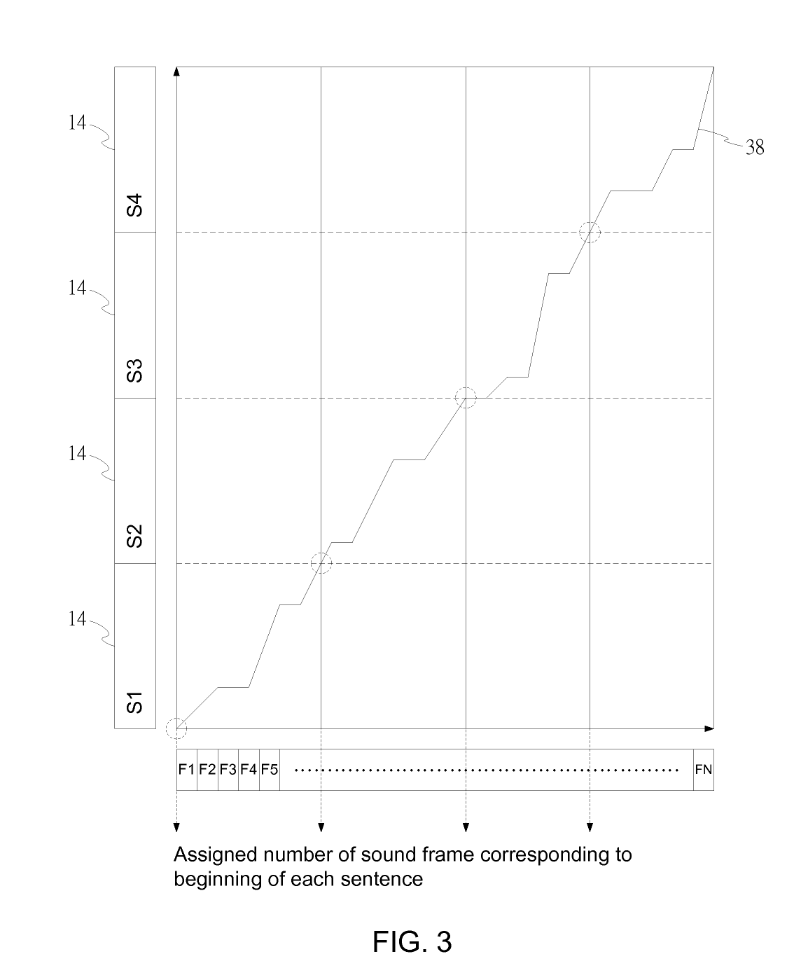

Please refer to FIG. 3. FIG. 3 is a graph of the best speech route. A second calculation module 36 calculate the best speech route 38 in accordance with the comparison probability calculated by the first calculation module 34 and by means of a second algorithm, in which Viterbi algorithm can be adopted in the second algorithm. Suppose that the text file 10 has four sentences S1, S2, S3 and S4 in sequence therein. First, these four sentences are sequentially transformed into speech models 14 and the speech file 12 corresponding to the text file 10 is then divided into a plurality of sound frames (F1 to FN). Furthermore, Viterbi algorithm takes the plurality of sound frames (F1 to FN) of the speech file 12 as the x-coordinate and the speech model 14 transformed from the text file 10 as the y-coordinate to process the recognition. A best speech route 38 most similar to all sound frames and speech models calculated by means of Viterbi algorithm can be obtained after the feature parameters of all sound frames in the speech file 12 are completely processed.

Please refer to FIG. 3 again. The assigned number of the sound frame corresponding to the beginning of each sentence can be captured through the best speech route 38. The starting time of the speech file 12 corresponding to the beginning of each sentence can be obtained in accordance with the assigned number of the sound frame of each sentence and the time interval covered by each sound frame.

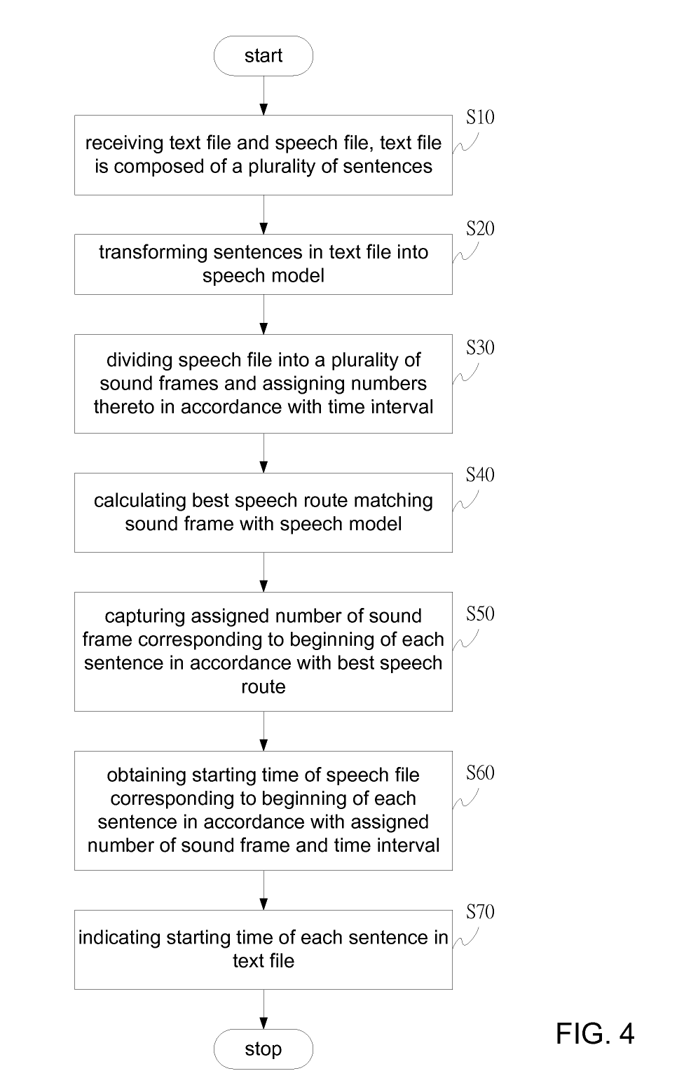

Please refer to FIG. 4. FIG. 4 is a flow chart of a method for automatically indicating time in a text file. The method comprises the following steps:

Step S10: receiving a text file and a speech file, in which the text file and the speech file are files corresponding to each other, and the text file is composed of a plurality of sentences.

Step 20: transforming the sentences in the text file into speech models, in which the speech model is belong to Hidden Markov Model.

Step 30: dividing the speech file received in Step 10 into a plurality of sound frames and assigning numbers thereto according to a time interval, in which the time interval is approximately 23 to 30 milliseconds.

Step 40: calculating the beat speech route matching the sound frames with the sound models, in which this step can be divided into three steps in detail, they will be introduced as below.

Step 50: capturing the assigned number of the sound frame corresponding to the beginning of each sentence in accordance with the best speech route.

Step S60: obtaining a starting time of the speech file corresponding to the beginning of each sentence in accordance with the assigned number of the sound frame and the time interval; because the time interval of the sound frame can be chosen by a user himself depending on the user's need or the requirements on calculation, the calculation of the starting time of each sentence can be obtained by multiplying the assigned number of the sound frame corresponding to the beginning of each sentence obtained in Step S50 and the time interval of each sound frame together.

Step S70: finally indicating the starting of the beginning of each sentence in the text file. Hence, the text file not only records a text content corresponding to the speech file but also records the starting time of the beginning of each sentence. Therefore, only if the speech file is started playing from the starting time of a certain sentence, a speech content corresponding to the text content of the sentence can be heard such so as to attain to the lyric sync function. Each sentence in the text file can be automatically indicated with the starting time corresponding to the speech file according to the method of the present invention so that it is unnecessary to manually indicate time as the prior art does and further saves a great amount of cost on time and man labor.

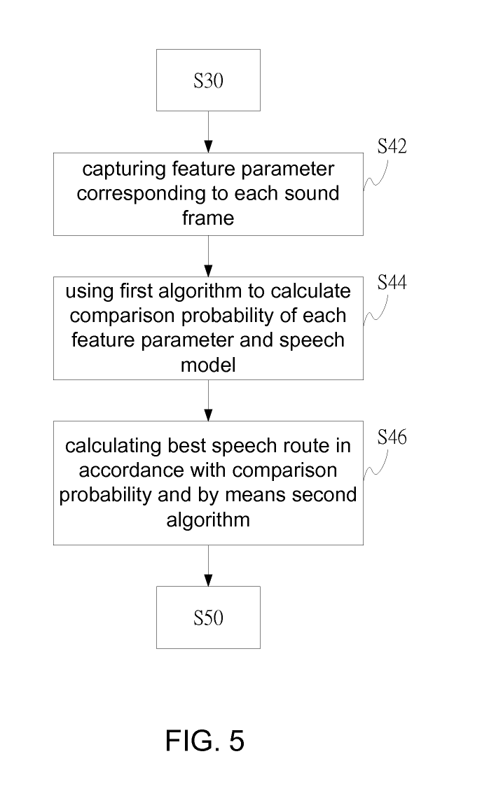

The best speech route matching the sound frame with the speech model is calculated in Step 40 comprising the following steps. Please refer to FIG. 5. FIG. 5 is a flow chart of a method for calculating the best route in detail.

Step S42: capturing a feature parameter corresponding to each sound frame. Although a voice signal is a dynamic signal varied with time, only if the regularity of each short time (sound frame) in the voice signal can be found out, no matter how the voice signal varies with time, where its characteristic locates can also be found out more or lest and the voice signal can further be recognized. Such kind of regularity on the speech recognition is known as a feature parameter, namely, a parameter capable of representing the characteristic of the voice signal. Therefore, the feature parameter of each sound frame is first captured to benefit for the follow-up process of the speech recognition.

Step S44: using a first algorithm to calculate comparison probability of each feature parameter and the speech model, in which the first algorithm can be a forward procedure algorithm or a backward procedure algorithm.

Step 46: calculating the best speech route in accordance with the comparison probability of each feature parameter and the speech model calculated in Step 44 and then by means of a second algorithm, in which Viterbi algorithm can be adopted in the second algorithm. Viterbi algorithm is used to calculate the best speech route as FIG. 3 shows, and the assigned number of the sound frame corresponding to the beginning of each sentence in the text file is then captured through the best speech route. The starting time of the speech file corresponding to the beginning of each sentence can then be obtained in accordance with the assigned number of the sound frame of each sentence and the time interval covered by each sound frame.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An apparatus for automatically indicating time in a text file, comprising:
a receiver module, receiving a text file and a speech file, the text file being composed of a plurality of sentences;
a speech recognition module, transforming the plurality of sentences in the text file into a speech model, dividing the speech file into a plurality of sound frames and assigning numbers thereto in sequence in accordance with a time interval and calculating a best speech route matching the plurality of sound frames with the speech model;
an indicator module, capturing the assigned number of the sound frame corresponding to a beginning of each sentence in accordance with the best speech route, obtaining a starting time of the speech file corresponding to the beginning of each sentence through the assigned number of the sound frame and the time interval and indicating the starting time in the text file.

2. The apparatus according to claim 1, wherein the speech model belongs to a Hidden Markov Model (HMM).

3. The apparatus according to claim 1, wherein the time interval is 23 to 30 milliseconds.

4. The apparatus according to claim 1, wherein the speech recognition module further comprises:
a capture module, capturing a feature parameter corresponding to each sound frame;
a first calculation module, using a first algorithm to calculate a comparison probability of each feature parameter and the speech model; and
a second calculation module, calculating the best speech route in accordance with the comparison probability and by means of a second algorithm.

5. The apparatus according to claim 4, wherein the first algorithm is a forward procedure algorithm.

6. The apparatus according to claim 4, wherein the first algorithm is a backward procedure algorithm.

7. The apparatus according to claim 4, wherein the second algorithm is a Viterbi algorithm.

8. The apparatus according to claim 1, wherein the starting time is obtained by multiplying the assigned number of the sound frame and the time interval together.

9. A method for automatically indicating time in a text file, comprising the following steps:
receiving a text file and a speech file, the text file being composed of a plurality of sentences;
transforming the plurality of sentences in the text file into a speech model;
dividing the speech file into a plurality of sound frame and assigning numbers thereto in sequence in accordance with a time interval;
calculating a best speech route matching the sound frames with the speech model;
capturing the assigned number of the sound frame corresponding to a beginning of each sentence in accordance with the best speech route;
obtaining a starting time of the speech file corresponding to the beginning of each sentence in accordance with the assigned number of the sound frame and the time interval; and
indicating the starting time in the text file.

10. The method according to claim 9, wherein the speech model belongs to a Hidden Markov Model (HMM).

11. The method according to claim 9, wherein the time interval is 23 to 30 milliseconds.

12. The method according to claim 9, wherein the speech recognition module further comprises:
capturing a feature parameter corresponding to each sound frame;
using a first algorithm to calculate a comparison probability of each feature parameter and the speech model; and
calculating the best speech route in accordance with the comparison probability and by means of a second algorithm.

13. The method according to claim 12, wherein the first algorithm is a forward procedure algorithm.

14. The method according to claim 12, wherein the first algorithm is a backward procedure algorithm.

15. The method according to claim 12, wherein the second algorithm is a Viterbi algorithm.

16. The method according to claim 9, wherein the starting time is obtained by multiplying the assigned number of the sound frame and the time interval together.
